(19) United States
(12) Patent Application Publication
(10) Pub. No.: US 2019/0266600 A1
(43) Pub. Date: Aug. 29, 2019

(54) SYSTEM AND METHOD FOR MONETARY TRANSACTION

(71) Applicant: Mahendra R, Bengaluru (IN)

(72) Inventor: Mahendra R, Bengaluru (IN)

(21) Appl. No.: 15/954,287

(22) Filed: Apr. 16, 2018

(30) Foreign Application Priority Data
Feb. 28, 2018 (IN) 201841007557

(51) Int. Cl. G06Q 20/38; G06Q 20/40

(52) U.S. Cl. CPC G06Q 20/388; G06Q 20/3278; G06Q 20/4014

(57) ABSTRACT

A system and method for monetary transaction are provided. The system includes a storage module configured to receive and store one or more credentials of at least one unique identity of a user and one or more credentials of at least one unique identity of a merchant. The system also includes a processing subsystem configured to verify the one or more credentials of the at least one unique identity of the user and the one or more credentials of the at least one unique identity of the merchant. The processing subsystem is also configured to register the user and the merchant with one or more financial institutions based on a verified result. The system further includes a transaction module configured to authenticate the monetary transaction between the user and the merchant through a communication medium. The transaction module is also configured to process the monetary transaction.

### CROSS-REFERENCE TO RELATED APPLICATION

This application claims the benefit of complete patent application having Patent Application No. 201841007557 filed on Feb. 28, 2018 in India.

### BACKGROUND

Embodiments of the present disclosure relate to money transaction, and more particularly to a system and method for monetary transaction.

Money transaction or monetary transaction is a type of transaction in which one financial institute makes a payment or incur a liability in terms of respective currency. Further, transaction can be made manually or electrical through an online platform. Electronic payments are also accepted by a number of vending machines, kiosks, automated teller machines or other systems without a human needed to conduct the transaction or process an electronic payment as tender for the transaction.

In one approach, a user makes the money transaction to a merchant through a bank account directly to the merchant account using a portal which leads the user to transact the money. The online portal is a third party interference to get access to the user bank account. The transaction happens through a communication medium such as web or internet. However, in such system, system the medium acts a third party who must be trust worthy. Also the transaction of money is not possible without receiving an approval from the third party. Further, such system asks the user to enter or scan the user details at every transaction.

In another approach, the transaction of money is made to the merchant account through digital wallets or any similar physical platform which allows the user to make transaction through electronic means such as a hand held device or a physical means such as a physical identifiable means such as debit or credit cards. In such system, the user's bank account or a user's deposit is linked to the digital wallet. The system eliminates the need of third party interference. The system also allows a transaction to happen swiftly. However, digital wallets are stored on a cloud of business servers which results in malfunction or shuts down anytime which makes the transaction process to stop abruptly which also increases traffic in the servers. Further, such system becomes ineffective without the connectivity to an internet access.

In yet another approach, the transaction of money is made through a payment networks which are linked to a payment card such as a debit card or a credit card wherein a bank or any other eligible financial institution can become a member to attribute the payment networks. Such systems help the user in national and international transactions of money. However, in such systems there is liability for uncertain card payments. Also the merchant has to pay a fraction of transaction to the financial institution for accepting the payment through payment networks. Also the user has to remember a plurality of user details to make the monetary transaction.

Hence, there is a need for an improved system and method for monetary transaction to address the aforementioned issues.

### BRIEF DESCRIPTION

In accordance with one embodiment of the disclosure, a system for monetary transaction is provided. The system includes a storage module configured to receive and store one or more credentials of at least one unique identity of a user and one or more credentials of at least one unique identity of a merchant. The system also includes a processing subsystem operatively coupled to the storage module. The processing subsystem is configured to verify the one or more credentials of the at least one unique identity of the user and the one or more credentials of the at least one unique identity of the merchant. The processing subsystem is also configured to register the user and the merchant with one or more financial institutions based on a verified result. The system further includes a transaction module operatively coupled to the processing subsystem. The transaction module is configured to authenticate the monetary transaction between the user and the merchant through a communication medium. The transaction module is also configured to process the monetary transaction.

In accordance with another embodiment of the disclosure, a method for monetary transaction is provided. The method includes receiving and storing one or more credentials of at least one unique identity of a user and one or more credentials of at least one unique identity of a merchant. The method also includes verifying the one or more credentials of the at least one unique identity of the user and the one or more credentials of the at least one unique identity of the merchant. The method further includes registering the user and the merchant with one or more financial institutions. The method further includes authenticating the monetary transaction between the user and the merchant. The method further includes processing the monetary transaction.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for monetary transaction in accordance with an embodiment of the present disclosure;

FIG. 2 is exemplary embodiment representing a system for monetary transaction of FIG. 1 in accordance with an embodiment of the present disclosure;

FIG. 3 is a block diagram of a computer or a server in accordance with an embodiment of the present disclosure; and

FIG. 4 is a process flow for monetary transaction in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and method for monetary transaction. The system includes a storage module configured to receive and store one or more credentials of at least one unique identity of a user and one or more credentials of at least one unique identity of a merchant. The system also includes a processing subsystem operatively coupled to the storage module. The processing subsystem is configured to verify the one or more credentials of the at least one unique identity of the user and the one or more credentials of the at least one unique identity of the merchant. The processing subsystem is also configured to register the user and the merchant with one or more financial institutions based on a verified result. The system further includes a transaction module operatively coupled to the processing subsystem. The transaction module is configured to authenticate the monetary transaction between the user and the merchant through a communication medium. The transaction module is also configured to process the monetary transaction.

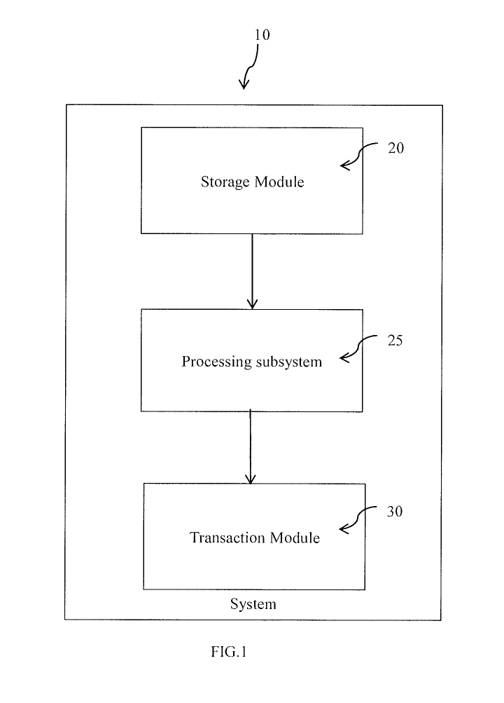

FIG. 1 is a block diagram of a system for monetary transaction in accordance with an embodiment of the present disclosure. The system (10) includes a storage module (20) configured to receive and store one or more credentials of at least one unique identity of a user and one or more credentials of at least one unique identity of a merchant. In one embodiment, the system (10) may include a centralized system or a distributed system.

In one embodiment, the storage module (20) may be a storage device on a computer system. In another embodiment, the one or more credentials of the at least one unique identity of the user and the one or more credentials of the at least one unique identity of the merchant may be stored on a remote server such as a cloud server.

As used herein, the credentials are a set of documents which has an attestation of certain stated true facts of a person. In one embodiment, the at least one unique identity of the user may be a driver license, a voter identification card, an adhaar card, a passport or a ration card of the user. In another embodiment, the at least one unique identity of the merchant may be a driver license, a voter identification card, an adhaar card, a passport or a ration card of the merchant. In one specific embodiment, the at least one unique identity of the user may include a biometric identification of the user. In another embodiment, the at least one unique identity of the merchant may include a biometric identification of the merchant.

In one embodiment, the user may be a person who may make the monetary transaction. In another embodiment, the user may be a customer or a client. In yet another embodiment, the merchant may be a person who may be involved in a business of selling goods or services.

The system (10) also includes a processing subsystem (25) operatively coupled to the storage module (20). The processing subsystem (25) is configured to verify the one or more credentials of the at least one unique identity of the user and the one or more credentials of the at least one unique identity of the merchant. In one embodiment, the one or more credentials of the at least one unique identity of the user which may be provided by the user may be verified by the processing subsystem (25) to check if a plurality of details provided by the user is valid or not. In another embodiment, the one or more credentials of the at least one unique identity of the user which may be provided by the user may be verified by a distributing agency to check for a kind of a malpractice which may be exercised while finding a forged document.

In yet another embodiment, the one or more credentials of the at least one unique identity of the merchant which may be provided by the merchant may be verified by the processing subsystem (25) to check if a plurality of details provided by the merchant is valid or not. In another embodiment, the one or more credentials of the at least one unique identity of the merchant which may be provided by the merchant may be verified by the distributing agency to check for a kind of a malpractice which may be exercised while finding a forged document.

The processing subsystem (25) is also configured to register the user and the merchant with one or more financial institutions based on a verified result. In one embodiment, if the one or more credentials of the at least one unique identity of the user was found to be valid after verifying, the user may be allowed to register with the one or more financial institutions. In another embodiment, if the one or more credentials of the at least one unique identity of the merchant was found to be valid after verifying, the merchant may be allowed to register with the one or more financial institutions. In one specific embodiment, the one or more financial institutions may be a bank, a credit union, insurance company or a mortgage company. In such embodiment, the one or more financial institutions may be one or more inter banks or one or more intra banks.

In yet another embodiment, if the one or more credentials of the at least one unique identity of the user was found to be invalid or not genuine; the user may not be allowed to register with the one or more financial institutions. In yet another embodiment, if the one or more credentials of the at least one unique identity of the merchant was found to be invalid or not genuine; the merchant may not be allowed to register with the one or more financial institutions.

The system (10) further includes a transaction module (30) operatively coupled to the processing subsystem (25). The transaction module (30) is configured to authenticate the monetary transaction between the user and the merchant through a communication medium. In one embodiment, the communication medium may include a short message service (SMS) communication medium. As used herein, SMS is a type of text messaging service in a mobile telephonic device. In one exemplary embodiment, the user may scan the one or more credentials of the at least one unique identity of the merchant through a scanning module on a hand held device. Further, a scanned detail of the merchant may be transmitted to the processing subsystem (25) of the system (10) through an SMS. Further, the processing subsystem (25) may send an authentication code to the merchant. In such embodiment, the authentication code may be a one-time password or any other type of password.

Referring back to the above mentioned exemplary embodiment, the merchant may share the authentication code received with the user to authenticate the monetary transaction between the user and the merchant. Further, the user may transmit the authentication code which may be shared by the merchant to the processing subsystem (25) through an SMS. Further, the processing subsystem (25) may verify the authentication code received by the user. Further, if the authentication code received by the user matches the authentication code sent by the processing subsystem (25) to the merchant, the transaction module may authenticate the monetary transaction between the user and the merchant.

Further, the transaction module (30) is configured to process the monetary transaction. Referring back to the above mentioned exemplary embodiment, the transaction module (30) may process the monetary transaction from the user to the merchant. In one embodiment, the user may enter a sum of amount to be transmitted to the merchant in the hand held device and transmit the sum of amount to the processing subsystem (25) through a communication medium. In such embodiment, the communication medium may be wireless communication medium such as Bluetooth, near field communication or the SMS. In another embodiment, the communication medium may be an optical medium, a sound medium, Unstructured Supplementary Service Data (USSD) or interactive voice response (IVR).

Further, the transaction module (30) may transfer the sum of amount mentioned by the user in the SMS from the one or more financial institutions of the user to the one or more financial institutions of the merchant. In one embodiment, the hand held device may be a mobile telephonic device. In one specific embodiment, the processing subsystem may be implemented with a machine learning model such as artificial intelligence which may be operatively coupled to the transaction module and may be configured for monetary transaction.

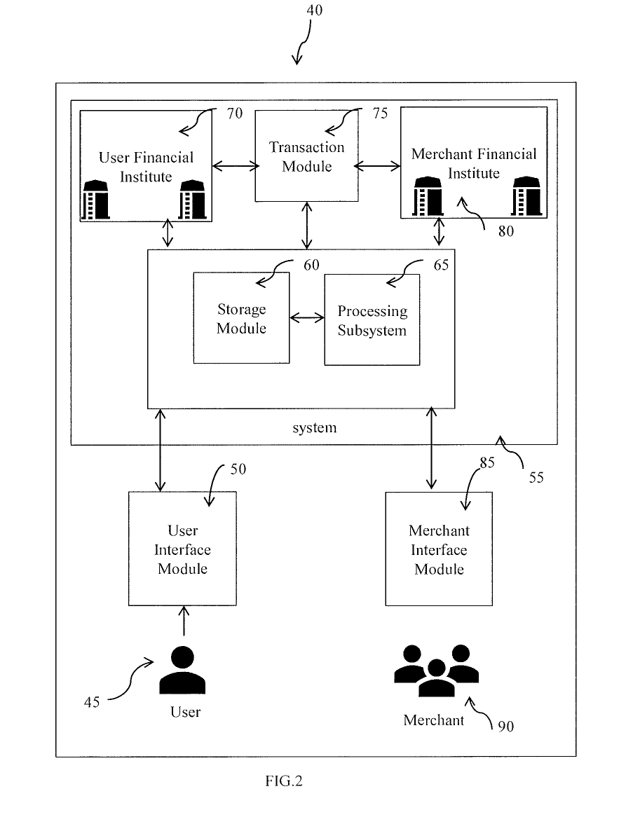

FIG. 2 is exemplary embodiment representing a system for monetary transaction of FIG. 1 in accordance with an embodiment of the present disclosure. For simplicity of understanding the disclosure, the description would be discussed with respect to an example for a system for monetary transaction. However, the example would not in any way restrict the application of the system in any other situation.

For example a (45) user may send a plurality of credentials of an adhaar card of the user through a user interface module (50). Further, the plurality of credentials of an adhaar card of the user may be transmitted to a system (55) through a communication medium, wherein the communication medium a Bluetooth medium, a near field communication (NFC) medium, an optical medium, a sound medium, an unstructured supplementary service data (USSD) medium, an Interactive voice response (IVR) medium or a short message service (SMS) communication medium. Further, the system (55) is substantially similar to a system (10) of FIG. 1.

Further, the plurality of credentials of an adhaar card of the user may be verified by a processing subsystem (65) which may be operatively coupled to the user interface device (50). Further, the plurality of credentials of an adhaar card of the user (45) may be stored in a storage module (60) of the system (55), wherein the storage module (60) is substantially similar to a storage module (20) of FIG. 1. Further a stored plurality of credentials of an adhaar card of the user (45) may be verified by the processing subsystem (65) to ensure that the plurality of credentials of the adhaar card provided by the user (45) is true. Further, on verifying the plurality of credentials of an adhaar card of the user (45), the processing system (65) may allow the user (45) to register with the system (55) and may connect the user (45) to a user financial institution (70).

Also, a merchant (90) may send a plurality of credentials of an adhaar card of the merchant (90) through a merchant interface module (85). Further, the plurality of credentials of an adhaar card of the merchant (90) may be transmitted to a system (55) through a communication medium, wherein the communication medium may be a short message service (SMS).

Further, the plurality of credentials of an adhaar card of the merchant (90) may be verified by a processing subsystem (65) which may be operatively coupled to the merchant interface device (85). Further, the plurality of credentials of an adhaar card of the merchant (90) may be stored in a storage module (60) of the system (55). Further a stored plurality of credentials of an adhaar card of the merchant (90) may be verified by the processing subsystem (55) to ensure that the plurality of credentials of the adhaar card provided by the merchant (90) is true. Further, on verifying the plurality of credentials of an adhaar card of the merchant (90), the processing system (65) may allow the merchant (90) to register with the system (55) and may connect the merchant (90) to a merchant financial institution (80).

Further, if the user (45) wants to make the monetary transaction with the merchant (90), the user (45) scans the adhaar card of the merchant (90) through the user interface module (50). Further, as the user (45) scans the adhaar card of the merchant (90), the plurality of credentials which may be linked with the adhaar cared of the merchant (90) may be transmitted to the system (55) in a form of a short service message (SMS) through the user interface module (50). Further, on receiving the SMS which may be sent by the user (45), the storage module (60) may verify the plurality of credentials which may be linked with the adhaar cared of the merchant (90). Further, on verifying the plurality of credentials of the merchant (90), the processing subsystem (45) may send an authentication code in the form of a SMS to the merchant interface module (85).

Further, the merchant (90) may share or may ask the user to input the authentication code received by the processing subsystem (45) through the user interface module (50). Further, the user (45) may enter the authentication code which the merchant (90) may have received. The user (45) may also input a sum of amount to be transmitted to the merchant (90) in the user interface module (50) and may transmit the authentication code and the sum of amount to the subsystem (55) through the SMS.

Further, the processing subsystem (55) on receiving the authentication code and the sum of amount which may be sent by the user through the user interface module (50), may verify the authentication code sent by the user (45) with the authentication code which may have been sent by the processing subsystem (65) to the merchant (90). Further, if the authentication code sent by the user (45) to the processing subsystem (65) matches the authentication code sent to the merchant (90) by the processing subsystem (65), then the processing subsystem (45) may authenticate the monetary transaction with the sum of amount which may be sent by the user (45) through the SMS to the processing subsystem (65).

Further, on authenticating the monetary transaction, the processing subsystem (65) may send a command to a transaction module to process the monetary transaction between the user (45) and the merchant (90), wherein the transaction module (75) is substantially similar to a transaction module (75) of FIG. 1. Further, the transaction module (75) on receiving the command from the processing subsystem (65), the transaction module (65) may instruct the user financial institute (70) to transfer the sum of amount requested by the user (45) to the merchant financial merchant (80), hence may complete the monetary transaction between the user (45) and the merchant (90) with the transaction of the sum of amount requested by the user (45).

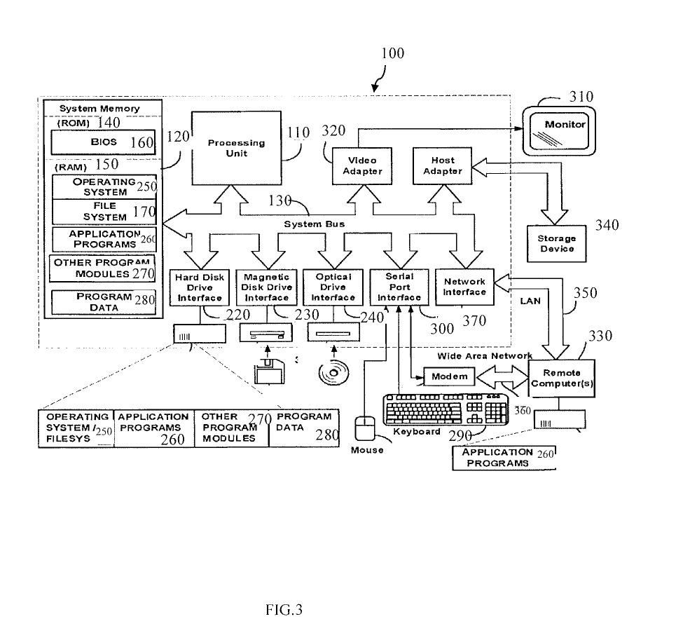

FIG. 3 is a block diagram of a computer or a server in accordance with an embodiment of the present disclosure. The exemplary system (100) for monetary transaction (10) includes a general-purpose computing device in the form of a computer (100) or a server or the like. The computer (100) includes a processing unit (110) substantially similar to the processing subsystem (25) of FIG. 1, and configured to verify the one or more credentials of the at least one unique identity of the user and the one or more credentials of the at least one unique identity of the merchant and to register the user and the merchant with one or more financial institutions based on a verified result. The computer (100) also includes a system memory (120) to a storage module (20) of FIG. 1.

The computer (100) further includes a system bus (130) that couples various system components including the system memory (100) to the processing unit (110). Further the system bus (130) is substantially similar to a communicating medium which is built between the, the processing subsystem (25), the storage module (20) and a transaction module (30) of FIG. 1.

The system bus (130) may be any of several types of bus structures including a memory bus or memory controller, a peripheral bus, and a local bus using any of a variety of bus architectures. The system memory (120) includes read-only memory (ROM) (140) and random access memory (RAM) (150) which is substantially similar to a memory of the processing hardware (20) of FIG. 1 configured to store a plurality of user details and a plurality of merchant details and the memory of the subsystem (60) of FIG. 2. A basic input/output system (BIOS) (160), containing the basic routines that help transfer information between elements within the computer (100), such as during start-up, is stored in ROM (140).

The computer (100) may further include a hard disk drive for reading from and writing to a hard disk, not shown, a magnetic disk drive for reading from or writing to a removable magnetic disk, and an optical disk drive for reading from or writing to a removable optical disk such as a CD-ROM, DVD-ROM or other optical media.

The hard disk drive, magnetic disk drive, and optical disk drive 30 are connected to the system bus by a hard disk drive interface (220), a magnetic disk drive interface (230), and an optical drive interface (240), respectively. The drives and their associated computer-readable media provide non-volatile storage of computer readable instructions, data structures, program modules and other data for the computer (100) to the various results generated from the data processing unit (110).

Although the exemplary environment described herein employs a hard disk, a removable magnetic disk and a removable optical disk, it should be appreciated by those skilled in the art that other types of computer readable median that can store data that is accessible by a computer, Such as magnetic cassettes, flash memory cards, digital video disks, Bernoulli cartridges, random access memories (RAMS), read-only memories (ROMs) and the like may also be used in the exemplary operating environment.

A number of program modules may be stored on the hard disk, magnetic disk, optical disk, ROM (140) or RAM (150), including an operating system (250). The computer (100) includes a file system (170) associated with or included within the operating system (250), one or more application programs (260), other program modules (270) and program data (280). A user may enter commands and information into the computer (100) through input devices (290) such as a keyboard and pointing device. Other input devices (not shown) may include a microphone, joystick, game pad, Satellite dish, Scanner or the like.

These and other input devices are often connected to the data processing unit (110) through a serial port interface (300) that is coupled to the system bus, but may be connected by other interfaces, such as a parallel port, game port or universal serial bus (USB). A monitor (310) or other type of display device is also connected to the system bus (130) via an interface. Such as a video adapter (320). In addition to the monitor (310), personal computers typically include other peripheral output devices (not shown), such as speakers and printers.

The computer (100) may operate in a networked environment using logical connections to one or more remote computers (330). The one or more remote computer (330) may be another computer, a server, a router, a network PC, a peer device or other common network node, and typically includes many or all of the elements described above relative to the computer (100), although only a memory storage device (340) has been illustrated. The logical connections include a local area network (LAN) (350) and a wide area network (WAN) (360).

When used in a LAN (350) networking environment, the computer (100) is connected to the local network (350) through a network interface or adapter (370). When used in a WAN (360) networking environment, the computer (100) typically includes a modem (380) or other means for establishing communications over the wide area network (360), such as the Internet.

The modem (380), which may be internal or external, is connected to the system bus (130) via the serial port interface (300). In a networked environment, program modules depicted relative to the computer (100), or portions thereof, may be stored in the remote memory storage device. It will be appreciated that the network connections shown are exemplary and other means of establishing a communications link between the computers may be used.

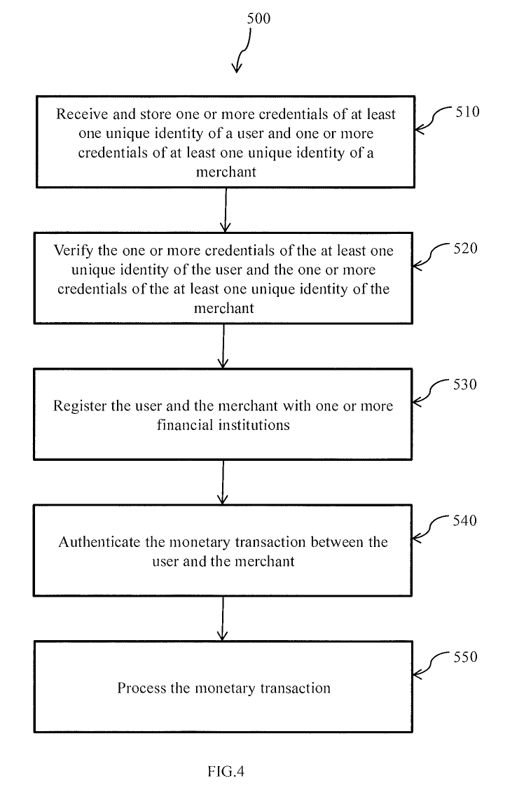

FIG. 4 is a process flow for monetary transaction in accordance with an embodiment of the present disclosure. The method (500) includes receiving and storing one or more credentials of at least one unique identity of a user and one or more credentials of at least one unique identity of a merchant (510). In one embodiment, receiving and storing the one or more credentials of the at least one unique identity of the user may include receiving the one or more credentials of the at least one unique identity of the user in a form of a short message service (SMS) which may be send by the user through a hand held device of the user. In such embodiment, the hand held device of the user may be a mobile telephonic device.

In another embodiment, receiving and storing the one or more credentials of the at least one unique identity of the merchant may include receiving the one or more credentials of the at least one unique identity of the merchant in a form of a short message service (SMS) which may be send by the merchant through a hand held device of the merchant. In such embodiment, the hand held device of the merchant may be a mobile telephonic device.

The method (500) also includes verifying the one or more credentials of the at least one unique identity of the user and the one or more credentials of the at least one unique identity of the merchant (520). In one embodiment, verifying the one or more credentials of the at least one unique identity of the user may include verifying the one or more credentials of the at least one unique identity of the user to know if the one or more credentials of the at least one unique identity which may be provided by the user is genuine or not.

In another embodiment, verifying the one or more credentials of the at least one unique identity of the merchant may include verifying the one or more credentials of the at least one unique identity of the merchant to know if the one or more credentials of the at least one unique identity which may be provided by the merchant is genuine or not.

The method (500) further includes registering the user and the merchant with one or more financial institutions (530). In one embodiment, the user may be allowed to be registered with the one or more financial institution if the one or more credentials of the at least one unique identity of the user may be verified with a positive result.

In another embodiment, the merchant may be allowed to be registered with the one or more financial institution if the one or more credentials of the at least one unique identity of the user may be verified with a positive result.

The method (500) further includes authenticating the monetary transaction between the user and the merchant (540). In one embodiment, authenticating the monetary transaction between the user and the merchant (540) may include receiving the verified result of the one or more credentials of the at least one unique identity of the merchant. In such embodiment, the user may send the one or more credentials of the at least one unique identity of the merchant which may be verified to initiate the monetary transaction which may be received by the system.

Authenticating the monetary transaction between the user and the merchant (540) may also include sending an authentication code to the merchant. In one embodiment, on receiving the verified result from the user, the merchant may receive an authentication code which may be shared with the user. Further, the user may transmit the authentication code shared by the merchant with the system.

Authenticating the monetary transaction between the user and the merchant (540) may further include receiving the authentication code from the user. In one embodiment, the authentication code which may be transmitted by the user may be received by the system for further monetary transaction. In such embodiment, the authentication code which may be transmitted by the user may match the authentication code which the merchant would have received. In such a case, the authentication of the monetary transaction between the user and the merchant may be completed.

The method (500) further includes processing the monetary transaction (550). In one embodiment, when the authentication code which may be transmitted by the user may match with the authentication code which may be received by the merchant, the monetary transaction which may be requested by the user may be processed.

Various embodiments of the system described above enable a system for monetary transaction between the user and the merchant. Further, the system makes the monetary transaction without the requirement of the web, which enables the system to be used at any instant of time.

Further, the system does not involve any third party to authenticate the monetary transactions between the user and the merchant which makes the system more trustworthy and secure. Further, since the system does not involve the third party, the system may be more secured from breakdown and the traffic for transaction is also reduced which makes the system faster.

Further, the user need not remember a plurality of details to make the monetary transaction. Also the system stops the user from paying a fraction of the transaction to the one or more financial institutions, which makes the system more liable.

Further, the system enables the monetary transaction between the user and the merchant by making use of the unique identity which is readily available by the user and the merchant. Hence the system saves the extra charges and time involved in generating a card for transacting money which makes the system cost effective.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system (10) for monitory transaction comprising:
a storage module (20) configured to receive and store one or more credentials of at least one unique identity of a user and one or more credentials of at least one unique identity of a merchant;
a processing subsystem (25) operatively coupled to the storage module (20), and configured to:
verify the one or more credentials of the at least one unique identity of the user and the one or more credentials of the at least one unique identity of the merchant;
register the user and the merchant with one or more financial institutions based on a verified result;
a transaction module (30) operatively coupled to the processing subsystem (25), and configured to:
authenticate the monetary transaction between the user and the merchant through a communication medium; and
process the monetary transaction.

2. The system (10) as claimed in claim 1, wherein the system comprises a centralised system or a distributed system.

3. The system (10) as claimed in claim 1, wherein the at least one unique identity of the user comprises a driver license, a voter identification card, an adhaar card, a passport, a permanent account number (PAN) card or a ration card of the user and the at least one unique identity of the merchant comprises a driver license, a voter identification card, an adhaar card, a passport, a permanent account number (PAN) card or a ration card of the merchant.

4. The system (10) as claimed in claim 1, wherein the one or more financial institutions comprises a bank, a credit union, insurance company or a mortgage company.

5. The system (10) as claimed in claim 1, wherein the communication medium comprises a Bluetooth medium, a near field communication (NFC) medium, an optical medium, a sound medium, an unstructured supplementary service data (USSD) medium, an Interactive voice response (IVR) medium or a short message service (SMS) communication medium.

6. The system (10) as claimed in claim 1, further the at least one unique identity of the user comprises a biometric identification of the user and the at least one unique identity of the merchant comprises a biometric identification of the merchant.

7. A method (500) for monitory transaction comprising:
receiving and storing one or more credentials of at least one unique identity of a user and one or more credentials of at least one unique identity of a merchant (510);
verifying the one or more credentials of the at least one unique identity of the user and the one or more credentials of the at least one unique identity of the merchant (520);
registering the user and the merchant with one or more financial institutions (530);
authenticating the monetary transaction between the user and the merchant (540); and
processing the monetary transaction (550).

8. The method (500) as claimed in claim 7, wherein authenticating the monetary transaction between the user and the merchant (540) comprises:
receiving the verified result of the one or more credentials of the at least one unique identity of the merchant;
sending a authentication code to the merchant;
receiving the authentication code from the user;
verifying the authentication code; and
authenticating the monetary transaction between the user and the merchant.

9. The method (500) as claimed in claim 8, wherein receiving the verified result of the one or more credentials of the at least one unique identity of the merchant comprises scanning the one or more credentials of the at least one unique identity of the merchant.

10. The method (500) as claimed in claim 8, wherein sending the authentication code to the merchant comprises sending the authentication code through a communication medium, wherein the communication medium comprises a Bluetooth medium, a near field communication (NFC) medium, an optical medium, a sound medium, an unstructured supplementary service data (USSD) medium, an Interactive voice response (IVR) medium or a short message service (SMS) communication medium.
